(19) United States
(12) Patent Application Publication
(10) Pub. No.: US 2026/0005985 A1
(43) Pub. Date: Jan. 1, 2026

(54) STRUCTURED RECONFIGURABLE WIRING FUNCTIONS THROUGH ROUTERS IN NETWORK-ON-CHIP

(71) Applicant: Baya Systems, Inc., Santa Clara, CA (US)

(72) Inventors: Joji PHILIP, San Jose, CA (US); Eric NORIGE, Santa Clara, CA (US); Avinash Jagdish PATIL, Bangalore (IN); Jatinkumar Vithalbhai FULTARIA, Bengaluru (IN)

(21) Appl. No.: 19/241,180

(22) Filed: Jun. 17, 2025

(30) Foreign Application Priority Data
Jun. 28, 2024 (NL) 2038082

(51) Int. Cl. H04L 49/253; H04L 49/25; H04L 49/65

(52) U.S. Cl. CPC H04L 49/254; H04L 49/251; H04L 49/65

(57) ABSTRACT

Systems and methods include a control layer and a Network on Chip (NoC). The NoC includes a plurality of routers interconnected with both packet transport wires and global support wires. The global support wires are specifically configured to distribute wired signal inputs to processing functions of the plurality of routers, as determined by the control layer. This configuration enables the control layer to effectively configure the processing functions of each router, thereby enhancing the efficiency and adaptability of the NoC to meet different operational demands.

### BACKGROUND

### Cross Reference to Related Applications

The present application claims priority to Dutch Patent Application No. 2038082, filed on Jun. 28, 2024, the contents of which are herein incorporated by reference in their entirety for all purposes.

### TECHNICAL FIELD

Methods and example embodiments described herein are generally directed to a router-based Network on Chip (NoC), and more specifically, for processing wired signal inputs within routers configured in a NoC.

### RELATED ART

The number of components on a chip is rapidly growing due to increasing levels of integration, system complexity, and shrinking transistor geometry. Complex System-on-Chips (SoCs) may involve a variety of components e.g., processor cores, Digital Signal Processors (DSPs), hardware accelerators, memory, and Input/Output (I/O) interfaces, while Chip Multi-Processors (CMPs) may involve a large number of homogenous processor cores, memory and I/O subsystems. In both systems, the on-chip interconnect plays a key role in providing high-performance communication between the various components. Due to scalability limitations of traditional buses and crossbar-based interconnects, Network-on-Chip (NoC) has emerged as a paradigm to interconnect a large number of components on the chip.

NoC is a global shared communication infrastructure made up of several routing nodes interconnected with each other using point-to-point physical links. Messages are injected by source components and are routed from the source components to a destination component over multiple intermediate nodes and physical links. The destination component then ejects the message and provides it to other components associated with the destination component. For the remainder of the document, terms ‘processing elements,’ ‘components,’ ‘blocks,’ ‘hosts,’ or ‘cores,’ will be used interchangeably to refer to the various system components which are interconnected using a NoC. The terms ‘routers’ and ‘nodes’ will also be used interchangeably. Without loss of generalization, the system with multiple interconnected components will itself be referred to as a ‘multi-core system’.

There are several possible topologies in which the routers can connect to one another to create the system network. Bi-directional rings 100A (as shown in FIG. 1A) and 2-D mesh 100B (as shown in FIG. 1B) are examples of topologies in the related art.

Packets are message transport units for intercommunication between various components. Routing involves identifying a path which is a set of routers and physical links of the network over which packets are sent from a source to a destination. Components are connected to one or multiple ports of one or multiple routers; with each such port having a unique identifier (ID). Packets carry the destination's router and port ID for use by the intermediate routers to route the packet to the destination component.

Examples of routing techniques include deterministic routing, which involves choosing the same path from A to B for every packet. This form of routing is oblivious to the state of the network and does not load balance across path diversities which may exist in the underlying network. However, such deterministic routing may be simple to implement in hardware, maintains packet ordering, and may be easy to make free of network-level deadlocks. Shortest path routing minimizes the latency as it reduces the number of hops from the source to the destination. For this reason, the shortest path is also the lowest power path for communication between the two components. Dimension-order routing is a form of deterministic shortest-path routing in 2D mesh networks.

FIG. 2 illustrates an example of XY routing in a two-dimensional mesh 200. The mesh is implemented as a grid having 3 columns and 4 rows. More specifically, FIG. 2 illustrates XY routing from node ‘13’ to node ‘00’. In the example of FIG. 2, each component is connected to only one port of one router. A packet is first routed in the X dimension till the packet reaches node ‘03’ where the x dimension is same as the destination. The packet is next routed in the Y dimension until the packet reaches the destination node.

Source routing and routing using tables are other routing options used in NoC. Adaptive routing can dynamically change the path taken between two points on the network based on the state of the network. This form of routing may be complex to analyze and implement and is therefore rarely used in practice.

An NoC may contain multiple physical networks. Over each physical network, there may exist multiple virtual networks, where different message types are transmitted over different virtual networks. In this case, at each physical link or channel, there are multiple virtual channels (VCs), each VC may have dedicated buffers at both end points. In any given clock cycle, only one VC can transmit data on the physical channel.

NoC interconnects often employ wormhole routing, where a large message or packet is broken into small pieces known as flits (also referred to as flow control digits). The first flit is the header flit which holds information about the packet's route and key message level information along with payload data and sets up the routing behavior for all subsequent flits associated with the message. Zero or more body flits follow the head flit, containing the remaining payload of data. The final flit is a tail flit which in addition to containing the last payload also performs some bookkeeping to close the connection for the message. In wormhole flow control, VCs are often implemented.

The physical channels are time-sliced into a number of independent logical channels, i.e. VCs. VCs provide multiple independent paths to route packets; however, they are time-multiplexed on the physical channels. A VC holds the state needed to coordinate the handling of the flits of a packet over a channel. At a minimum, this state identifies the output channel of the current node for the next hop of the route and the state of the virtual channel (idle, waiting for resources, or active). The VC may also include pointers to the flits of the packet that are buffered on the current node and the number of flit buffers available on the next node.

The term “wormhole” refers to the way messages are transmitted over the channels: the output port at the next router can be so short that received data can be translated in the head flit before the full message arrives. This allows the router to quickly set up the route upon arrival of the head flit and then opt-out from the rest of the conversation. Since a message is transmitted flit by flit, the message may occupy several flit buffers along its path at different routers, creating a worm-like image.

Based on the traffic between various end points, and the routes and physical networks that are used for various messages, different physical channels of the NoC interconnect may experience different levels of load and congestion. The capacity of various physical channels of a NoC interconnect is determined by the width of the channel (number of physical wires) and the clock frequency at which it is operating. Various channels of the NoC may operate at different clock frequencies. However, all channels are equal in width or number of physical wires. This width can be determined based on the most loaded channel and the clock frequency of various channels.

Systems-on-chip also contain several functions which involve globally distributing events or settings from parts of the system to other parts of the system. Examples are resets, interrupts, flow control information etc. These are usually not efficiently communicated using packetized messages on the system interconnect but are implemented using “global wires” that directly communicate these events or settings. Global wires require low and predictable latency, high reliability and efficient implementation. These signals cannot be made into packets and transported over other channels as that can cause delays and reduce their reliability.

Even though global wires are mostly just wires, there is often a small amount of logic in their construction that is necessary for their proper functioning. For example, an interrupt network will need OR gates added at merge points to combine interrupt signals from different sources into a single interrupt notification. A reset network can need synchronizers near its destinations to ensure that reset is asserted/deasserted in a clock-aligned manner. Flow control networks can have multiple sources and multiple destinations within the chip, and are expected to aggregate and convey a signal from all the sources to all the destinations. The implementation of global wires is usually left as a functional definition in the Register Transfer Layer (RTL) design and only when partitions go through Physical Design (PD) are the details of the implementation worked out.

### SUMMARY

A problem with global wires is that they are difficult to complete physical design as the structure of the network has to be entirely added late in the process. When a Network on Chip (NoC) is built, its logical structure is built to match the floorplan of the chip. This invention improves the process of building SoC by leveraging the logical structure of the NoC to help organize global wires, greatly reducing the physical design work needed. To do this, it is necessary to add to the NoC an unusual ability, the ability to process the signals contained in these global wires inside the routers.

By additionally making this processing of the global wires programmable, the functionality of the global networks becomes field-adjustable and spare resources for building global networks can be built into the product and enabled only when they are needed.

Aspects of the present disclosure are directed to a system that includes a control layer, and a Network on Chip (NoC) that includes a plurality of routers interconnected with packet transport wires and global support wires, the global support wires configured to distribute wired signal inputs to processing functions of the plurality of routers configured by the control layer, and where the control layer configures the processing functions of the plurality of routers.

Additional aspects of the present disclosure may further be directed to a NoC that includes a plurality of routers interconnected with packet transport wires and global support wires, the global support wires configured to distribute wired signal inputs to processing functions of the plurality of routers configured by a control layer, and where the processing functions of the plurality of routers are configured by the control layer.

Further aspects of the present disclosure may further be directed to a method that includes configuring processing functions of a plurality of routers of the NoC through a control layer, wherein the plurality of routers are interconnected with packet transport wires and global support wires and distributing wired signal inputs to the processing functions of the plurality of routers via the global support wires.

### BRIEF DESCRIPTION OF THE DRAWINGS

FIGS. 1A and 1B illustrate examples of Bidirectional ring and 2D Mesh Network on Chip (NoC) topologies.

FIG. 2 illustrates an example of XY routing in a NoC having a two-dimensional mesh topology.

FIG. 3A illustrates a schematic representation of a system having a control layer and a NoC implementing structured reconfigurable wiring functions, in accordance with an example implementation.

FIG. 3B illustrates a schematic representation of a router having multiple CF blocks, in accordance with an example implementation.

FIG. 3C illustrates a schematic representation of a CF block, in accordance with an example implementation.

FIG. 4A illustrates an example usage of global support wires where signals from sources have to be ORed and passed to all the destinations. This illustrates an ad hoc realization of that signal distribution.

FIG. 4B illustrates an implementation of the global distribution from FIG. 4A using the example implementations described herein.

FIG. 5 illustrates a flowchart of a method for distributing the wired signal inputs to the processing functions of the routers, in accordance with an example implementation.

FIG. 6 illustrates a computer/server block diagram upon which the example implementations described herein may be implemented.

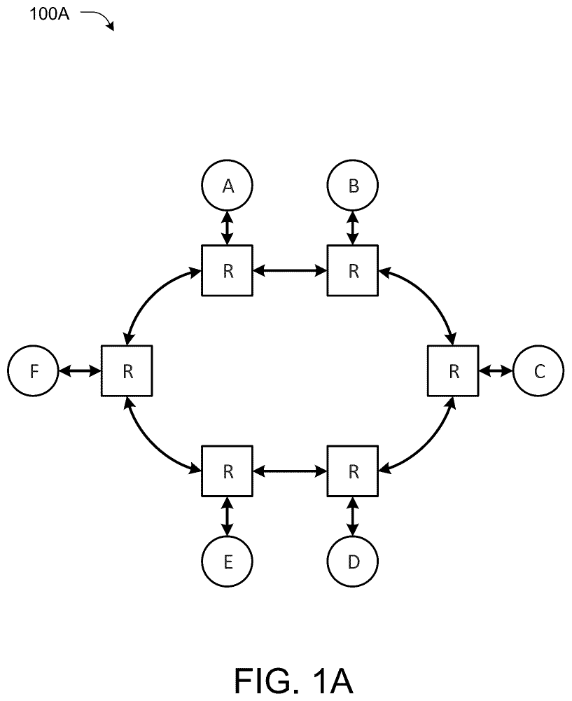

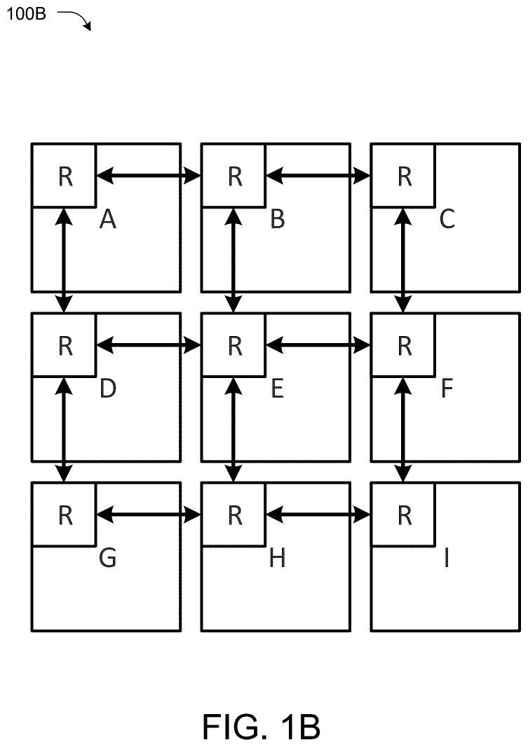

### DETAILED DESCRIPTION

The primary function of a Network on Chip (NoC) is packet transport, i.e. moving flits containing tens to hundreds of bits from a source component (e.g., source router) to a destination component (e.g., destination router). As introduced the background section, instead of handling the global support wires during the physical implementation phase completely independent of the system NoC, the current invention proposes logically specifying, designing and managing the global support wires along side the wiring and routing resources being provisioned for packetized communication of the traffic from main band functions. This approach structures the implementation of global wires to share the routing channels and logic blocks already present to implement the system interconnect NoC. This approach eases the physical design handling of these global wires and provides suitable places to apply logic transformation functions on these wires as they are routed between blocks of the system.

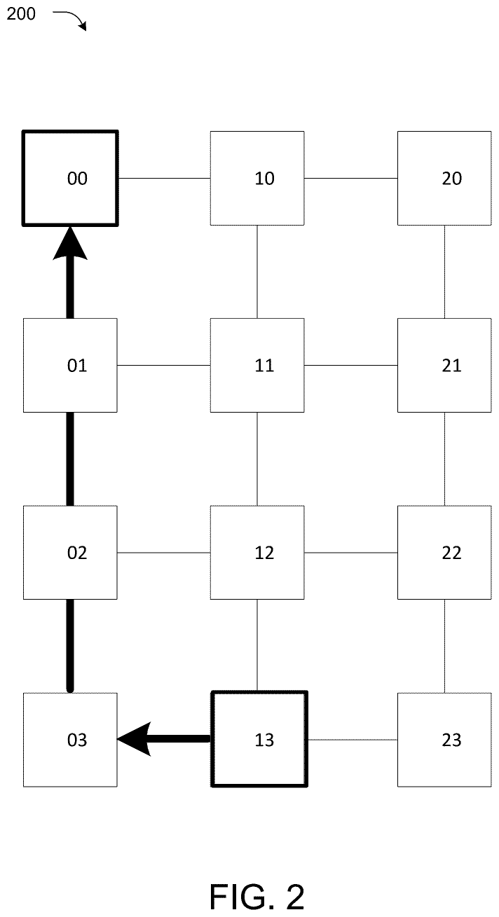

For example, a congestion control mechanism may require communicating a congestion state from a plurality of receiver/destination components using a subset of routers to a plurality of transmitters/source components (i.e. components that initiate transmission of data) using another subset of routers. One way to do this, such as in a NoC that has a grid topology as shown in FIG. 2, is to use separate wires between each source and destination, and combine the state of all destinations at each transmitter. This is expensive, especially for large systems, as many wires can be needed. For example, when each destination is connected to each source using wires, the number of wires increases quadratically as the number of components grows in the NoC. Another way to do this is to collect all the inputs at a single component/coordination point, compute the aggregate of the inputs at that component, and then broadcast from that component to all destinations. This will also be more difficult to implement as it requires ad-hoc wiring to and from the coordination point, and the coordination pattern must be determined at design time.

Unlike the existing NoC systems, the present disclosure includes a control layer that dynamically configures processing functions of each router of the NoC, thereby incorporating structured reconfigurable wiring functions. Global support wires between routers allow wired signal inputs to be passed through processing functions of different routers. The processing function process/transform wired signal inputs, and generate output wired signals. Unique configurations of processing functions of each router, and arrangements of the routers can be created to form processing networks that perform a predetermined operation/task. By aligning the structure of the processing networks with the pattern of communication between routers (such as by placing the global support wires alongside/parallelly to the packet transport wires), the wiring is easier to route during chip backend processes as it follows the paths of existing wires. Further, the present disclosure resolves the aforementioned problems and allows for efficient coordination, runtime configurability with inexpensive implementation, ease of backend-design, and so on.

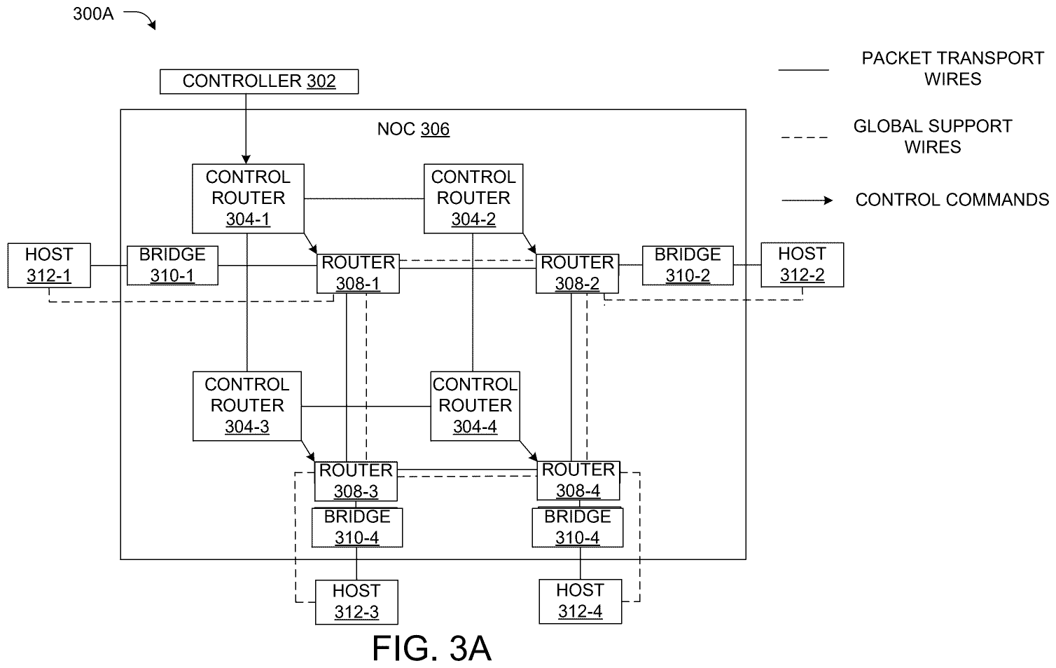

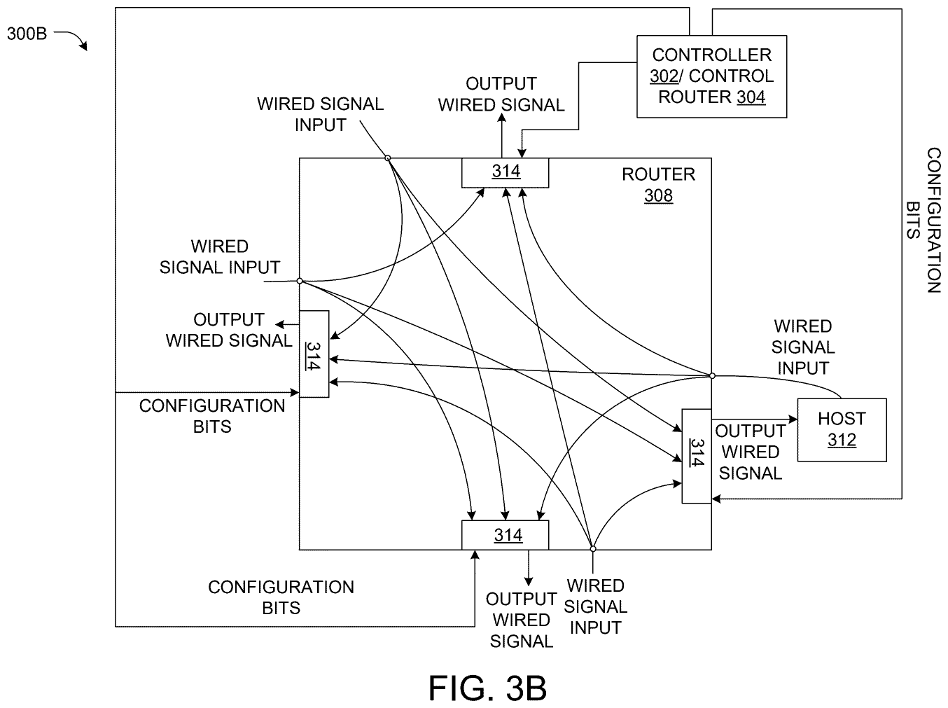

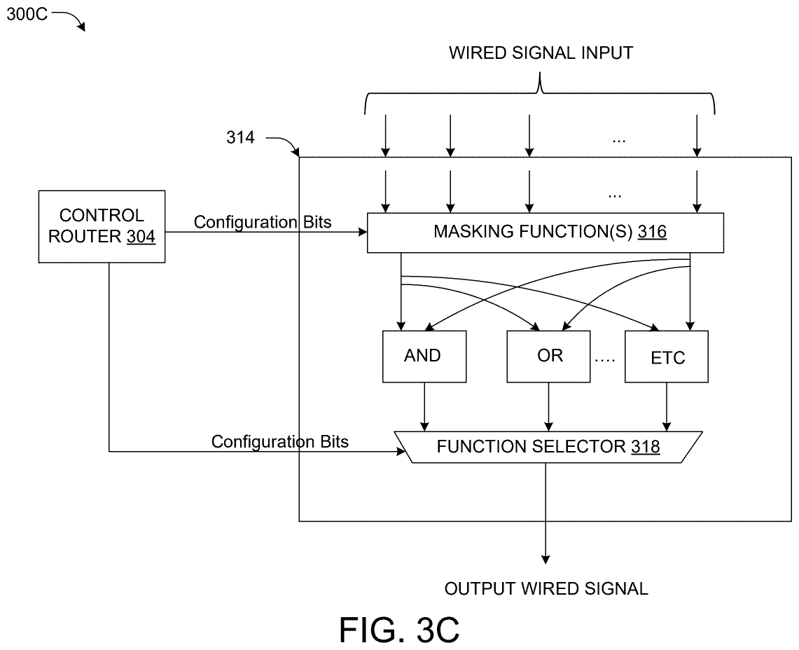

FIG. 3A illustrates a schematic representation 300A of a system having a control layer and a NoC 306 implementing structured reconfigurable wiring functions, in accordance with an example implementation. The system includes a control layer, and a NoC 306 having one or more routers 308-1 to 308-4 (collectively referred to as routers 308). The routers 308 are further connected to hosts 312-1 to 312-4 (collectively referred to as hosts 312) through bridges 310-1 to 310-4 (collectively referred to as bridges 310). In some embodiment, each router 308 may be associated with more than one host 312. While FIG. 3A illustrates a system with a NoC having 4 routers with a 2×2 grid topology, it may be appreciated that the system may be suitably adapted for NoC with any number of routers in any desired topology.

The routers 308 are interconnected using packet transport wires (indicated by solid lines), and global support wires (indicated by dashed lines). The packet transport wires and the global support wires may run alongside each other in the NoC 306. Placing the global support wires alongside packet transport wires allows for easier routing during chip backend processes. In an embodiment, the packet transport wires may be configured to transmit data packets across the routers 308 and the global support wires may be configured to distribute wired signal inputs (which are in the form of bits) to one or more processing functions. The processing functions may be implemented using one or more Configurable Function (CF) blocks (as subsequently shown and described in FIGS. 3B and 3C) of the routers 308. In some non-limiting examples, the global support wires may be implemented as circuit switched wires.

The routers 308 intake the wired signal inputs at ports defined by the control layer, execute the processing functions on the wired signal inputs, and generate an output wired signal. Execution of the processing function transform the wired signal inputs into output wired signals. The processing functions are (re)configurable by the control layer. The control layer may configure the processing functions to select all or a subset of wired signal inputs to operate on. The control layer may also configure the processing function to select the operation to be performed on the selected wired signal inputs. The processing functions may be dynamically reconfigurable by the control layer at runtime. Further, the processing functions operating on signals from the global support wires may eliminate the need for arbitration.

The control layer may be either implemented internally or externally to the NoC 306. The control layer includes a controller 302 and one or more control routers 304-1 to 304-4 associated with a corresponding router 308-1 to 308-4. The controller 302 may issue control commands to configure the processing functions of the routers 308. In some embodiments, the controller 302 may directly configure the processing functions to perform a desired operation. In other embodiments, the controller 302 may transmit control commands to the control routers 304 for configuring the processing functions. Each control router 304 is connected to each other to allow for command commands from the controller 302 to be propagated from one control router 304 to other control routers 304. In some embodiments, the controller 302 may be a processing element that operates based on a set of processor-executable instructions (i.e. a software). The control routers 304 may be circuits that receive and store the control commands from the controller 302. The control commands may then be used by the control router 304 to configure/control the processing functions of the routers 308.

The router 308 includes one or more CF blocks that receive and process wired signal inputs received from the global support wires. FIG. 3B illustrates a schematic representation 300B of routers 308 having multiple CF blocks 314, in accordance with an example implementation. As shown, the routers 308 may include one or more CF blocks 314. The number of CF blocks 314 may depend on the topology of the NoC 306, the position of the router 308 in the topology, the number of operations/processing functions required for a processing network, and the like. The CF blocks 314 may be the processing functions of the routers 308. Each CF block 314 may receive the wired signal inputs through input ports of the router 308 and execute the processing functions based on the inputs to generate the output wired signal.

The CF blocks 314 may receive the wired signal inputs from various sources. At least a set of wired signal inputs may be injected into routers 308 of the NoC 306 from a host 312 or a monitoring function. The output wired signal may be transmitted/ejected to other routers 308, the host 312, or the monitoring function. The output wired signals may also be ejected to other functions associated with the same router 308 that received and processed the wired signal inputs. Further, the output wired signals may be received as wired signal inputs by the other routers 308. In some embodiments, the host 312 may correspond to processing elements or other components connected to the router 308, but are external to the NoC 306. In an embodiment, the wired signal inputs may be received from other routers 308 from router-to-router ports (or directional ports). The number of router-to-router ports may depend on the topology implemented by the NoC 306, and the position of the router 308 in the NoC 306. For example, when the NoC 306 has a topology similar to NoC of FIG. 2, some routers 308 may have four router-to-router ports (such as ‘11’ of FIG. 2), and other routers at the edge (such as routers ‘02’ in FIG. 2) or corner (such as routers ‘03’ in FIG. 2) of the NoC grid may have 3 or 2 router-to-router ports respectively. The wired signal inputs may also be received from the host 312 through corresponding bridges 310, such as using host-to-router ports. In some examples, the monitoring function may refer to a congestion monitoring module within the NoC 306. The monitoring function may be designed to detect congestion levels in various areas of the NoC 306.

In an embodiment, the global support wires may distribute wired signal inputs to the processing functions of the routers 308. In an embodiment, the wired signal inputs may refer to various types of signals including control signals, synchronization signals, and the like (or generally other function signals), which may be transmitted as one or more bits.

The wired signal inputs may be received and directed towards output ports of the router 308 for processing said wired signal inputs. In some embodiments, each CF block 314 may be associated with one output port of the router 308. In some embodiments, each output port may have more than one CF block 314, where each CF block 314 may be associated with a different processing function/processing network that performs different operations/tasks. The example in FIG. 3B shows each output port having one CF block 314. The CF blocks 314 may generate the output wired signal based on the wired signal inputs, which may be transferred to another router 308 through the global support wires, or ejected to the corresponding host 312 (such as through router-to-host ports or ejection ports), or to functions associated with the same router 308 that received and processed the wired signal inputs.

The CF blocks 314 may be configurable by the control layer to perform different operations/tasks. The CF blocks 314 of the routers 308 may be configured by the control layer using control commands issued to each router 308. The control layer may be the same control layer that manages routing paths, data flow, and the like, across the network of routers of the NoC 306.

The processing function may generate the output wired signals using the wired signal inputs, based on its configuration. Upon execution/processing of the wired signal inputs, the CF blocks 314 may generate the output wired signal which is ejected/transferred to other external components (such as the hosts 312) or other routers 308 (such as from router 308-1 to router 308-2) in the NoC 306 through the output ports.

The CF blocks 314 may be a set of circuits that transform the wired signal inputs into output wires signals. FIG. 3C illustrates a schematic representation 300C of a CF block 314, in accordance with an example implementation. The CF blocks 314 include masking functions 316, operators/transformation functions/circuits, and a function selector 318. Once the wired signal inputs are received through input ports of the router 308 and directed to the CF block 314, the masking function 316 may determine which bits/inputs to select for processing by the operators and which bits/inputs to ignore based on the configuration of the masking function 316. In some embodiments, a single masking function 316 may be used for masking one or more of the wired signal inputs. In other embodiments, multiple masking functions 316 may be used for masking the wired signal inputs for each operator/transformation function. The configuration of the masking function 316 may be changed by the control layer using configuration bits (either directly or through the control router 304). The masking function 318 may enable the CF block 314 to focus only on relevant bits from the inputs for processing.

The operators/transformation functions of the routers 308 are configured to perform specific operations or tasks to transform the inputs. For example, the operators may include, but not be limited to, logical operators such as OR, XOR, AND, NAND, etc., multiplexing (MUX), mathematical operations, and the like. The operators may be implemented as a set of circuits that are adaptable to perform such operations. The CF blocks 314 may apply the operators on the wired signal inputs received through the global support wires. For example, the processing function of one router 308 may OR-reduce activity status received from one or more of the source routers as wired signal inputs, and transmit output wired signals to one or more of the destination routers. The CF blocks 314 may prioritize certain bits over others based on predefined criteria. In such embodiments, the control layer may configure the CF blocks 314 to process a first subset of wired signal inputs and ignore/discard a second subset of wired signal inputs.

The bits of the wired signal inputs masked by the masking function 316 may be transmitted/passed through the operators. In the example shown in FIG. 3C, the operators may include the operators “AND”, “OR”, etc. Each operator/transformation function may combine or modify the bits/inputs in different ways based on the logical rules of that operation.

In an embodiment, upon processing the inputs using the operators, outputs/results of each of the operators are then presented to the function selector 318. The function selector 318 may be a multiplexer (MUX) that is configured to select the output/result of one operator/transformation function. The multiplexer/function selector 318 may also be configurable by the control layer using configuration bits. The selected output/result may be transmitted as the output wired signal from the CF block 314. This output wired signal may be sent to other components within the NoC 306, such as a different router or host 312, through the global support wires. The global support wires may allow the output wired signals to be distributed to the CF block 314 in other routers 308, which may further execute functions and distribute the output wired signals therefrom.

In some embodiments, the control layer may reconfigure the global support wires from which the processing functions may receive the wired signal inputs. For example, the control layer may reconfigure the processing functions such that wired signal inputs from a first subset of global support wires are processed and wired signal inputs from a second subset of global support wires are ignored/discarded. The control layer may be configured to (re)program the processing functions in the routers 308 at run-time. In some embodiments, the control layer may be configured to dynamically reprogram the processing functions to perform a different function, based on requirements.

The masking function 316 and the function selector 318 may be configured by transmitting the command signals thereto. The command signals may be transmitted directly from the controller 302 or through the control router 304 of the control layer. The control commands include configuration bits that indicate the desired configuration for the CF blocks 314 of the routers 308. The control routers 304 may receive and store the configuration bits in the control commands, and configure the processing functions CF blocks 314 based on the configuration bits. The masking function 316 and the function selector 318 use the configuration bits to determine which wired signal inputs may be processed and which outputs of the operators are to be used for generating the output wired signal. The CF block 314, since it is connected to an output port, will either eject the output wired signal to the host 312 or transmit the output wired signal to another router 308.

The processing functions may allow the routers 308 (or processing functions therein) to perform functions indicative of congestion indication, congestion gathering interruptions, activity status sharing, priority elevations, end-to-end crediting/global credit distribution, and the like. For example, the control signal may be configured to change routing techniques of the routers 308 based on current workloads, power consumption, and the like. In such examples, the output wired signals may be transmitted to a control function of the router 308 aside from the host or other adjacent router, which may allow the router 308 to change routes for packets being transmitted therethrough. Similarly, the synchronization signals may be configured to synchronize the operations of different processing elements/hosts 312, which may be crucial in a multicore processor where different cores need to operate in coordination. Further, the configuration signals may also (re) configure operational parameters of the hosts 312 during runtime to adapt to changing performance requirements, such as reallocating resources in the multicore processors for different tasks.

In some implementations, the CF blocks 314 of the routers 308 may be configured to intake the wired signal inputs at ports (e.g., the input ports) defined by the control layer, and execute the configured processing functions on the wired signal inputs to generate the output wired signal to one of the global support wires. For example, if the control layer specifies that port A in the router 308 is designated for receiving the synchronization signals, the router 308 may be configured to recognize and intake the synchronization signals at Port A. Once the synchronization signals are received at port A, the router 308 may execute specific processing functions on the synchronization signals, as configured by the control layer. Once the synchronization signals are processed, the router 308 may generate the output wired signal that is transmitted to other components or other routers 308 through the global support wires (e.g. circuit switched wires). In some instances, the output wired signal may be received as wired signal inputs by the destination router 308, and may be processed by processing functions thereof. In other instances, the output wired signals may be sent to the hosts 312 of the router 308 for processing.

In some embodiments, processing functions may be implemented in multiple routers 308 in the NoC 306 to form a processing network. For example, in a processing network, the routers 308 may be arranged such that their processing functions form an OR-ing tree converging on at least one of the routers 308. In an embodiment, the processing network may have either a fan-in or a fan-out configuration, or a combination thereof. For example, a first subset of routers may fan-in wired signal inputs to a central router, which may fan-out output wired signals to a second subset of routers in the NoC 306. In such embodiments, the routers 308 may use broadcasting means to send or receive wired signals to and/or from other routers. The arrangement of the routers 308 and/or the configuration of the processing functions may allow for multiple processing networks to be implemented on the NoC 306. Further, the reconfigurability of the processing functions using the control layer may allow different processing networks to be dynamically implemented based on requirements.

In some implementations, the processing network may also perform certain operations such as congestion detection, route selection based on congestion, and the like. For example, one or more of the (destination) routers may fan-in signals to at least one central router. The central router may have its processing function configured as an “AND” operator. When all the (destination) routers fan into the central router, an output wired signal may be ejected to the monitoring function or a host 312 associated therewith. The output wired signal may indicate detection of high levels of traffic in a specific area that the (destination) routers belong to. Upon detecting high levels of traffic congestion in the specific area, the monitoring function may transmit signals through the NoC 306. The signals may instruct the control layer/routers 308 of the NoC 306 to reroute data traffic from the congested area to less busy areas, thereby alleviating the congestion. This redistribution of data traffic may maintain efficient data flow across the NoC 306, thereby preventing potential bottlenecks (for example, but not limited thereto) that may affect the overall performance of the NoC 306.

In some embodiments, each of the routers 308 may be configured to pre-process the wired signal inputs through a register circuit or a synchronization circuit (not shown). The wired signal inputs may be registered/stored by the register circuit before processing the wired signal inputs. Further, the synchronization circuit may synchronize the wired signal inputs that or of different clock domains, before they are processed by the processing function. For example, if synchronization signals are not aligning with a processing cycle of the routers, the register circuit may capture and hold the synchronization signals, effectively buffering the synchronization signals until the routers begin a next processing cycle. When the next processing cycle starts, the synchronization signals may be released from the register circuit and processed by the routers 308. For example, when the routers receive the synchronization signals, the synchronization circuit may align the incoming synchronization signals with the internal operation, thereby effectively synchronizing processing activities within the NoC 306. This synchronization may be useful when processing high-speed data or when executing real-time computing tasks, thereby ensuring that all components of the NoC 306 operate in a coordinated and efficient manner.

### Example Scenario

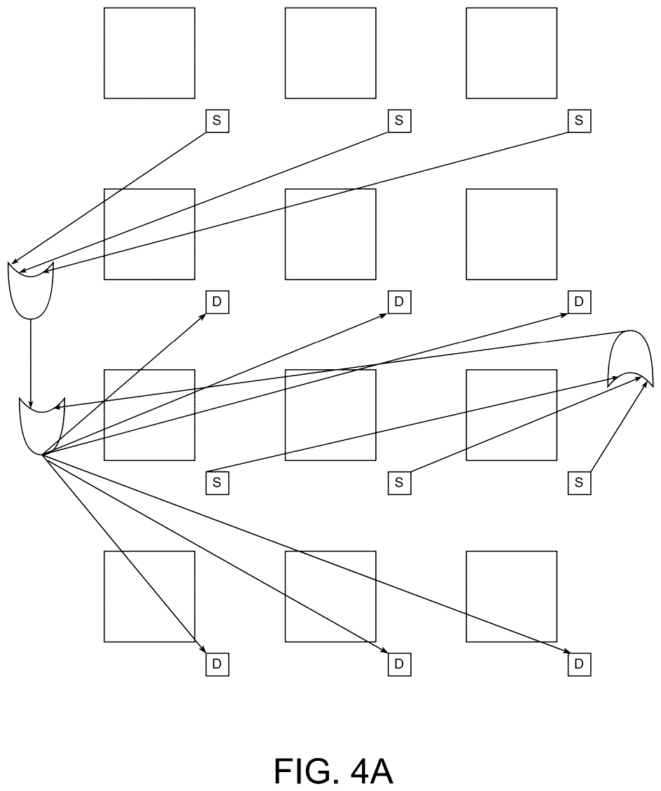

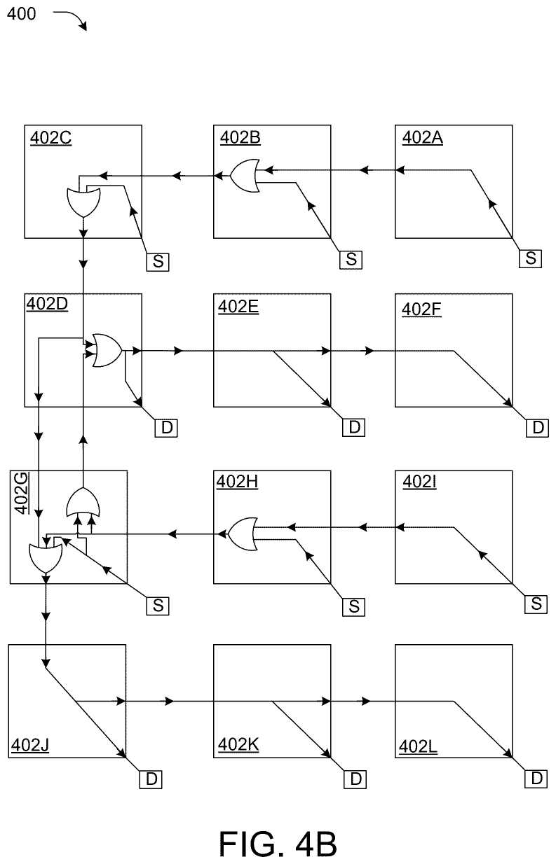

FIG. 4A Illustrates a schematic representation of a system with a global wire connecting 6 sources to 6 destinations. Each of the sources is labeled “S” and the destinations are labeled “D”. In this network, when any of the sources send an alert, all receivers will quickly find about this alert being raised. To accomplish this, three OR gates are shown, with two of them combining groups of sources into a single bit, and then these bits are combined and distributed to all destinations. Doing physical design of this specification will be quite difficult.

FIG. 4B illustrates a schematic representation of an example processing network 400 in a NoC. In existing NoCs separate wires may be required between each of the routers for transmitting signals therebetween. In the example shown in FIG. 2 where the NoC has a 3×4 grid topology, 17 wires are used to connect each router to every adjacent router. The signals transmitted through such wires may also be used for a predefined purpose, which may be determined at design time. Such wires also provide limited flexibility in combining signals from multiple sources and broadcasting the processed signals to multiple destinations. However, using the system of the present disclosure, the same functionality can be achieved using fewer number of wires. The signals may be processed by processing functions that are connected to the global support wires, which do not require other external processing elements/components for processing. Further, the run-time configurability of the system may allow the signals to be processed differently based on the requirements.

Referring to FIG. 4B, the routers 402A-402L may be arranged in a grid-like pattern (i.e. a 3×4 grid), to facilitate communication between the routers 402A-402L, which is denoted with arrows that may represent the paths for bits/signals to move from one router to another router. However, the routers 402A-402L of the present disclosure may not be limited to have a grid topology, and it may be appreciated by those skilled in the art that the routers 402A-402L may be suitably adapted to have any topology. The direction of the arrows indicates the flow of bits/signals. The bits may be transmitted from source routers (such as routers 402A to 402C, and 402G to 402I associated with source hosts that inject signals into the NoC 306) to different destination routers (such as routers 402D to 402F, and routers 402J to 402L associated with destination hosts/components to which the signals are ejected to from the NoC 306). The source hosts are represented by blocks ‘S’ and the destination components are represented by ‘D’. The destination routers may be positioned adjacent or vertically or horizontally to the source routers.

In some embodiments, the signals may correspond to single bits. The bits may include one or more Boolean values, such as string of 0s and 1s that are independent of each other in some examples. The signals passing through the global support wires may be transformed or processed within a single router to produce the output passed from one router to another. The signals may be transformed using processing functions in the routers 308. In the example shown in FIG. 4B, processing functions indicative of OR gates are configured or enabled in at least a subset of routers from the routers 402A-402L. The OR gate is a digital logic gate that receives two or more inputs and generates one output based on logical disjunction of the inputs. The output of the OR gate is true when at least one of its inputs is true.

The arrangement of the router, and the configuration of the processing function thereof form a processing network that performs an intended function. In the processing network 400 shown in FIG. 4B, the OR gates are used to combine the wired signal inputs from different routers and/or inputs from hosts and then send a single output signal to another router. In the NoC, the use of OR gates may serve multiple purposes, including coordination/stop signal distribution, where the gate outputs the coordination signal if there is a request from any of its input lines/wires, or in the facilitation of routing path selections that allow packets to take alternative routes to avoid congestion or to manage bandwidth allocation efficiently, for example. However, processing functions may not be limited to OR gates, and may be (re)configurable, as described subsequently in the present disclosure. The signals passing through the global support wires may allow for coordination between the routers.

In the example shown in FIG. 4B, the global support wires and the processing functions within the routers may be arranged such that each of the destination routers receive a logical OR of the values injected by any of the source routers. For example, if any one of the source routers injects a Boolean signal indicative of ‘1’ into the global support wires, all the destination routers receive the Boolean signal ‘1’. Meanwhile, if none of the source routers inject the Boolean signal ‘1’, then all the destination routers receive the Boolean signal ‘0’. The Boolean signal may be any signal having a Boolean value representation of some information to be communicated from the source routers to the destination routers, such as for coordination or synchronization.

To illustrate, if the source router 402B injects the Boolean signal ‘1’, said Boolean signal (being a wired signal input) may be transmitted to source router 402C. The processing function of the source router 402C may be configured to execute an OR logical operator, which, in response to receiving the Boolean signal (as wired signal input), may generate another Boolean signal (now an output wired signal indicating ‘1’) to the destination router 402D. The destination router 402D may receive the Boolean signal (as input wired signal from source router 402C), and use its processing function to send further global support wires (as output wired signals) to source router 402G and destination router 402E. The processing function in the destination router 402D may be configured to execute an OR operator that generates the output wired signal as a logical OR of wired signal inputs received from source routers 402C and 402G. The destination router 402E may further send Boolean signals to destination router 402F. Each of the destination routers may be configured to eject the ‘1’ in the signals to their corresponding hosts.

When the source router 402G receives the Boolean signal from the destination router 402D, the source router 402G may further convey the Boolean signal to the destination router 402J (which in turn may relay the Boolean signal to destination router 402K, 402L). The global support wires may be configured such that the Boolean signal from the destination router 402D are distributed to those CF blocks 314 of the source router 402G that direct their output wired signals to destination router 402J to prevent the source router 402G from returning the Boolean signal to the destination router 402D, thereby avoiding situations where two routers indefinitely send each other signals. In some examples, the global support wires may distribute the Boolean signal (as wired signal input) from the destination router 402D to all CF blocks 314 of the source router 402G, but the control layer may configure the CF blocks 314 such that only one of the CF blocks 314 of the source router 402G is configured to process the wired signal inputs from the destination router 402D and all other CF blocks 314 of the source router 402G mask/ignore the wired signal inputs from the destination router 402D. Meanwhile, the source router 402G may have another CF block 314/processing function that receives wired signal inputs (being Boolean signals) from its host, or from source router 402H, where such wired input signals are processed to generate output wired signals (also being Boolean signals) directed towards the destination router 402D.

The processing network described above is provided by way of an example, and the arrangements of routers and configuration of processing functions thereof may not be limited thereto. The NoC 306 may implement multiple processing networks that operate concurrently. For example, each processing network may utilize a subset of CF blocks 314 in each router 308. In some implementations, the subset of CF blocks utilized by each of the processing networks may be mutually exclusive, and in other implementations, each subset may have overlapping CF blocks 314. For example, the two or more global support wires may be placed between each of the routers to allow for bidirectional communication. The flow of bits in a first direction may be associated with a first processing network and the flow bits in a second direction may be associated with a second processing network, since different CF blocks 314 of the router 314 may be utilized for sending signals in each direction. In other examples, two or more processing networks may converge at a common CF block 314. The CF block 314 may participate as a part of one or more of the processing network based on the configuration of its masking function 316 and function selector 318. The NoC 306 may also implement heterogenous processing networks, where one or more of the processing networks may exchange signals to interact with each other.

Further, the aforementioned example is described in the context of the NoC having a topology as shown in FIG. 4B, it may be understood by those skilled in the art that the configuration of the global support wires and the processing functions/CF blocks 314 (and generally the processing network) may be suitably adapted to operate in other topologies. For example, instead of source routers 402C, 402G and destination routers 402D, 402J enabling vertical communication, source routers 402B, 402H may generate or receive signals from adjacent source routers 402C, 402A, or 402G, 402I respectively, and sent to destination routers 402E and 402K respectively. Further, the configuration of the global support wires and the processing functions/CF blocks 314 to provide other functionality based on requirements.

The present disclosure may provide flexibility in transforming the wired signal inputs as they are passed along the global support wires. Such signals may be used for the routers to communicate and perform coordination tasks, such as congestion management, but not limited thereto. Since the processing functions in routers of the NoC operate on the wired signal inputs are reconfigurable, the present disclosure may provide for enhanced flexibility in using and adapting the global support wires and the processing functions for a plurality of tasks. Further, the use of configurable processing functions may also allow the number of global support wires in the NoC to be reduced. While typical solutions may require each router to be connected to every other router (which implies the number of wires increases quadratically or polynomially as the number of routers increase based on their topology), the present disclosure eliminates the need for every source and destination router to be connected with each other, thereby minimizing the number of global support wires.

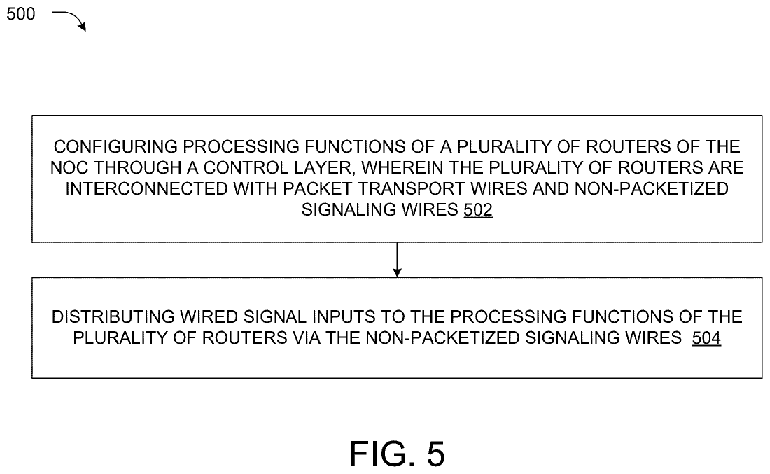

FIG. 5 illustrates a flowchart of a method 500 for distributing wired signal inputs to processing functions of routers, in accordance with an example implementation.

Referring to FIG. 5, at 502, the method 500 may include configuring processing functions of a plurality of routers of a NoC (e.g. 406) through a control layer (e.g. 404), where the plurality of routers may be interconnected with packet transport wires and global support wires. At 504, the method 500 may include distributing wired signal inputs to the processing functions of the plurality of routers via the global support wires. In an embodiment, processing functions may be configured for each output ports of the plurality of routers. In an embodiment, the method 500 may include intaking the wired signal inputs at ports defined by the control layer, executing the configured processing functions on the wired signal inputs, and generating an output wired signal to a corresponding one of the global support wires. In an embodiment, at least a set of the wired signal inputs may be injected from a host or a monitoring function. In an embodiment, the method 500 may include pre-processing the wired signal inputs through a register circuit or a synchronization circuit.

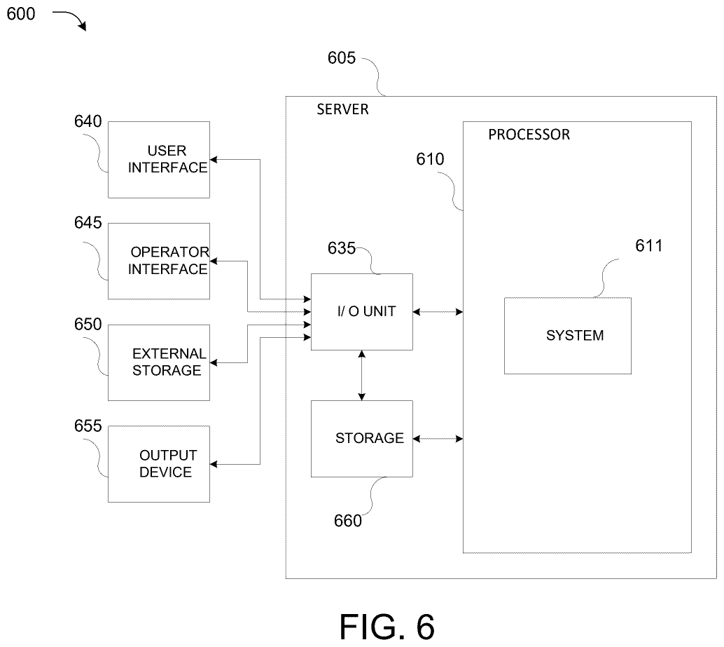

FIG. 6 illustrates an example computer system 600 on which example embodiments may be implemented. The computer system 600 includes a server 605 which may include an I/O unit 635, storage 660, and a processor 610 operable to execute one or more units as known to one of skill in the art. The term “computer-readable medium” as used herein refers to any medium that participates in providing instructions to processor 610 for execution, which may come in the form of computer-readable storage mediums, such as, but not limited to optical disks, magnetic disks, read-only memories, random access memories, solid state devices and drives, or any other types of tangible media suitable for storing electronic information, or computer-readable signal mediums, which can include transitory media such as carrier waves. The Input/Output (I/O) unit 635 processes input from user interfaces 640 and operator interfaces 645 which may utilize input devices such as a keyboard, mouse, touch device, or verbal command.

The server 605 may also be connected to an external storage 650, which can contain removable storage such as a portable hard drive, optical media (CD or DVD), disk media, or any other medium from which a computer can read executable code. The server may also be connected to an output device 655, such as a display to output data and other information to a user, as well as request additional information from a user. The connections from the server 605 to the user interface 640, the operator interface 645, the external storage 650, and the output device 655 may be via wireless protocols, such as the 802.11 standards, Bluetooth® or cellular protocols, or via physical transmission media, such as cables or fiber optics. The output device 655 may therefore further act as an input device for interacting with a user.

The processor 610 may execute one or more modules. The width adjustment module 611 is configured to determine and/or adjust a width for each of a plurality of channels in a NoC (e.g., 406) based on at least one performance objective for each of the plurality of channels or a maximum flow of the each of the plurality of channels, such that at least one of the plurality of channels has a different width than at least another one of the plurality of channels. The processor 610 may use a NoC to allow components/cores thereof to communicate with each other. The processor 610 further include a system 611 that configures processing functions of a plurality of routers of the NoC through a control layer and distributes wired signal inputs to the processing functions of the plurality of routers via global support wires.

Furthermore, some portions of the detailed description are presented in terms of algorithms and symbolic representations of operations within a computer. These algorithmic descriptions and symbolic representations are the means used by those skilled in the data processing arts to most effectively convey the essence of their innovations to others skilled in the art. An algorithm is a series of defined steps leading to a desired end state or result. In the example embodiments, the steps carried out require physical manipulations of tangible quantities for achieving a tangible result.

Moreover, other implementations of the example embodiments will be apparent to those skilled in the art from consideration of the specification and practice of the example embodiments disclosed herein. Various aspects and/or components of the described example embodiments may be used singly or in any combination. It is intended that the specification and examples be considered as examples, with a true scope and spirit of the embodiments being indicated by the following claims.

What is claimed is:

1. A system, comprising:
a Network on Chip (NoC), comprising:
a plurality of routers interconnected with packet transport wires and global support wires, the global support wires configured to implement global wire functionality with processing functions within the plurality of routers.

2. The system of claim 1, wherein the processing functions are configured for each output port of the plurality of routers.

3. The system of claim 1, wherein each of the plurality of routers is configured to:
intake the wired signal inputs at ports defined by the control layer;
execute the configured processing functions on the wired signal inputs; and
generate an output wired signal to a corresponding one of the global support wires.

4. The system of claim 1, wherein at least a set of the wired signal inputs are injected from a host or a monitoring function.

5. The system of claim 1, wherein each of the plurality of routers is configured to pre-process the wired signal inputs through a register circuit or a synchronization circuit.

6. The system of claim 1, further comprising a control layer configured to reconfigure the processing functions within the routers.

7. A Network on Chip (NoC), comprising:
a plurality of routers interconnected with packet transport wires and global support wires, the global support wires configured to distribute wired signal inputs to processing functions of the plurality of routers configured by a control layer; and wherein the processing functions of the plurality of routers are configured by the control layer.

8. The NoC of claim 7, wherein the processing functions are configured for each output port of the plurality of routers.

9. The NoC of claim 7, wherein each of the plurality of routers is configured to:
intake the wired signal inputs at ports defined by the control layer;
execute the configured processing functions on the wired signal inputs; and
generate an output wired signal to a corresponding one of the global support wires.

10. The NoC of claim 7, wherein at least a set of the wired signal inputs are injected from a host or a monitoring function.

11. The NoC of claim 7, wherein each of the plurality of routers is configured to pre-process the wired signal inputs through a register circuit or a synchronization circuit.

12. The NoC of claim 7, wherein the control layer is a component of the NoC.

13. A method for a Network on Chip (NoC), comprising:
configuring processing functions of a plurality of routers of the NoC through a control layer, wherein the plurality of routers are interconnected with packet transport wires and global support wires; and
distributing wired signal inputs to the processing functions of the plurality of routers via the global support wires.

14. The method of claim 13, wherein the processing functions are configured for each output port of the plurality of routers.

15. The method of claim 13, further comprising:
intaking the wired signal inputs at ports defined by the control layer;
executing the configured processing functions on the wired signal inputs; and
generating an output wired signal to a corresponding one of the global support wires.

16. The method of claim 13, wherein at least a set of the wired signal inputs are injected from a host or a monitoring function.

17. The method of claim 13, further comprising pre-processing the wired signal inputs through a register circuit or a synchronization circuit.
